(19) United States
(12) Patent Application Publication
(10) Pub. No.: US 2025/0322065 A1
(43) Pub. Date: Oct. 16, 2025

(54) REPAIRING DEVICE, REPAIRING METHOD AND REPAIRING PROGRAM

(71) Applicant: NIPPON TELEGRAPH AND TELEPHONE CORPORATION, Tokyo (JP)

(72) Inventors: Nariyoshi CHIDA, Musashino-shi, Tokyo (JP); Yuta IWAKI, Musashino-shi, Tokyo (JP)

(73) Assignee: NIPPON TELEGRAPH AND TELEPHONE CORPORATION, Tokyo (JP)

(21) Appl. No.: 18/869,861

(22) PCT Filed: Jun. 7, 2022
(86) PCT No.: PCT/JP2022/022968

§ 371 Date: Nov. 27, 2024

(51) Int. Cl. G06F 21/55

(52) U.S. Cl. CPC G06F 21/554; G06F 2221/034

(57) ABSTRACT

A correction device includes processing circuitry configured to extract a first regular expression from a source code, determine whether the first regular expression satisfies a condition indicating that the first regular expression is vulnerable to Regular Expression Denial of Service (ReDoS), and synthesize a second regular expression that does not satisfy the condition on a basis of the first regular expression.

### TECHNICAL FIELD

The present invention relates to a correction device, a correction method, and a correction program.

### BACKGROUND ART

In the real world, a regular expression is implemented as a regular expression engine, and is used in various situations. For example, the regular expression engine is used to check whether a character string input by a user is an email address in a web application with a screen for inputting an email address. In addition, for example, the regular expression engine is adopted for sanitization of data transmitted from the outside, extraction of elements, a standard library of a general-purpose programming language, and the like.

Here, an analysis algorithm based on a backtracking method adopted in many regular expression engines has a disadvantage that a huge amount of time is required for processing depending on a combination of data to be analyzed and a regular expression. A Regular Expression Denial of Service (ReDoS) is known as a cyberattack that exploits such a disadvantage (reference: “Regular expression Denial of Service—ReDoS”, https://owasp.org/www-community/attacks/Regular_expression_Denial_of_Service_-ReDoS).

Note that a regular expression that operates in linear time on the regular expression engine with respect to the length of the character string to be matched is called an invulnerable regular expression. On the contrary, a regular expression that operates, for example, in exponential function time on the regular expression engine with respect to the length of the character string to be matched is called a vulnerable regular expression.

Conventionally, as a technique for removing a ReDoS threat, RFixer (see, for example, Non Patent Literature 1) for correcting an error of a language that is accepted by a regular expression is known. In addition, there is known a method of obtaining an invulnerable regular expression by converting a pure regular expression into a deterministic finite automaton once and back to a regular expression (see, for example, Non Patent Literature 2).

### CITATION LIST

### Non Patent Literature

Non Patent Literature 1: Rong Pan, Qinheping Hu, Gaowei Xu, and Loris D'Antoni. 2019. Automatic Repair of Regular Expressions. Proc. ACM Program. Lang. 3, OOPSLA, Article 139 (October 2019), 29 pages.
Non Patent Literature 2: Brink van der Merwe, Nicolaas Weideman, and Martin Berglund. 2017. Turning Evil Regexes Harmless. In Proceedings of the South African Institute of Computer Scientists and Information Technologists (SAICSIT'17). Association for Computing Machinery, New York, NY, USA, Article 38, 10 pages.

### SUMMARY OF INVENTION

### Technical Problem

However, the related technique has a problem that it may be difficult to efficiently correct the vulnerability of the regular expression used in the real world.

For example, the technique described in Non Patent Literature 1 corrects an error in the regular expression, and does not correct vulnerability. In addition, for example, the technique described in Non Patent Literature 2 does not support correction of syntax such as lookahead, lookbehind, and backreference, which are extensions widely used in the real world.

In addition, in practical use, a vulnerable regular expression may be used on a source code of a program in which a regular expression engine is used. On the other hand, the related technique is not specialized for vulnerable regular expression correction in the source code.

### Solution to Problem

In order to solve the above problem and achieve the object, a correction device includes: an extraction unit that extracts a first regular expression from a source code; a determination unit that determines whether the first regular expression satisfies a condition indicating that the first regular expression is vulnerable to ReDoS; and a synthesis unit that synthesizes a second regular expression that does not satisfy the condition on a basis of the first regular expression.

### Advantageous Effects of Invention

According to the present invention, it is possible to efficiently correct vulnerability of a regular expression used in the real world.

### BRIEF DESCRIPTION OF DRAWINGS

FIG. 1 is a diagram illustrating a configuration example of a correction device according to a first embodiment.

FIG. 2 is a diagram illustrating an example of a syntax of a regular expression.

FIG. 3 is a diagram describing a method for extracting a list of regular expressions.

FIG. 4 is a diagram illustrating an example of an NFA.

FIG. 5 is a diagram illustrating an example of a path on an NFA.

FIG. 6 is a diagram illustrating examples of positive examples and negative examples.

FIG. 7 is a diagram describing a method for generating a set of character strings.

FIG. 8 is a diagram describing a method for synthesizing a regular expression.

FIG. 9 is a flowchart illustrating a flow of processing of the correction device according to the first embodiment.

FIG. 10 is a flowchart illustrating a flow of regular expression correction processing.

FIG. 11 is a flowchart illustrating a flow of regular expression synthesis processing.

FIG. 12 is a diagram illustrating an example of a computer that executes a correction program.

### DESCRIPTION OF EMBODIMENTS

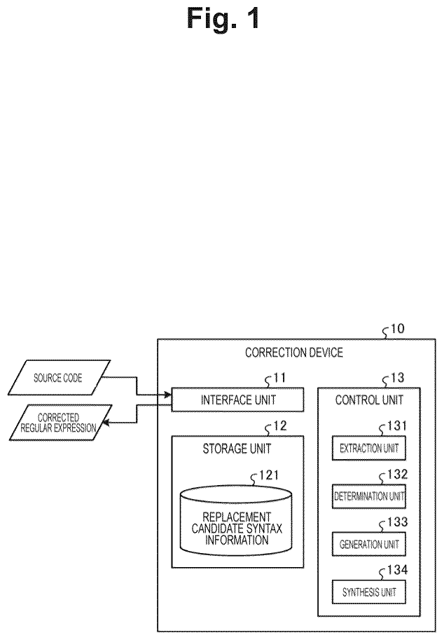

Hereinafter, an embodiment of a correction device, a correction method, and a correction program according to the present application will be described in detail with reference to the drawings. Note that the present invention is not limited to the embodiment described below.

[Configuration of First Embodiment] First, a configuration of a correction device according to a first embodiment will be described with reference to FIG. 1. FIG. 1 is a diagram illustrating an example of a configuration of a correction device according to the first embodiment. As illustrated in FIG. 1, a correction device 10 receives an input of a source code, corrects a regular expression included in the input source code, and outputs the corrected regular expression.

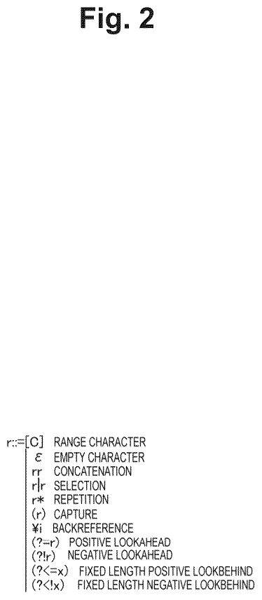

Here, the regular expression in the present embodiment is a regular expression with extension in the real world, and is assumed to follow the syntax defined in Backus-Naur form (BNF). FIG. 2 is a diagram illustrating an example of a syntax of a regular expression. A regular expression r in FIG. 2 is an example of the regular expression in the present embodiment. Note that, in the following description, “¥” in the regular expression may be replaced with backslash as appropriate.

In FIG. 2, “C” is a set of characters, “x” is a character string, and “i” is a natural number. The syntax in FIG. 2 is what is utilized in existing regular expression engines (reference: “Perldoc Browser”, https://perldoc.perl.org/perlre.html).

In addition, “.” is a symbol representing one arbitrary character. That is, “.” is a syntax sugar with respect to the range character “[C]” in FIG. 2. In addition, a set of characters that do not match the range character “[C]” can be written as “[\hat{ }C]”. In addition, the empty set is written as “[ ]”, which means that it does not match any character.

Returning to FIG. 1, each unit of the correction device 10 will be described. As illustrated in FIG. 1, the correction device 10 includes an interface unit 11, a storage unit 12, and a control unit 13.

The interface unit 11 is an interface for inputting/outputting data and communicating data. For example, the interface unit 11 receives an input of data from an input device such as a keyboard and a mouse. In addition, for example, the interface unit 11 outputs data to an output device such as a display and a speaker.

In addition, the interface unit 11 may be a device (for example, a network interface card (NIC)) for performing communication via a network.

The storage unit 12 is a storage device such as a hard disk drive (HDD), a solid state drive (SSD), or an optical disk. Note that the storage unit 12 may be a semiconductor memory capable of rewriting data, such as random access memory (RAM), flash memory, or non-volatile static random access memory (NVSRAM). The storage unit 12 stores an operating system (OS) and various programs executed by the correction device 10.

The storage unit 12 stores replacement candidate syntax information 121. The replacement candidate syntax information 121 is a set of regular expression or template syntaxes that are replaced with range characters or holes.

For example, the replacement candidate syntax information 121 is “□□, □|□, □*, (□), ¥i, (?=□), (?!□), (?<=□), (?<!□)”. Where, “□” is a hole. Holes and templates will be described below.

The control unit 13 controls entire the correction device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

In addition, the control unit 13 includes an internal memory for storing programs and control data defining various processing procedures, and executes pieces of processing by using the internal memory. In addition, the control unit 13 functions as various processing units by various programs operating. For example, the control unit 13 includes an extraction unit 131, a determination unit 132, a generation unit 133, and a synthesis unit 134.

The extraction unit 131 extracts the regular expression before correction from the source code. In addition, the determination unit 132 determines whether the regular expression before correction satisfies a condition indicating that the regular expression before correction is vulnerable to ReDoS. Then, the synthesis unit 134 synthesizes the corrected regular expression that does not satisfy the condition on the basis of the regular expression before correction.

Note that the regular expression before correction is an example of the first regular expression. In addition, the corrected regular expression is an example of the second regular expression.

As described above, the synthesis unit 134 performs correction processing on the regular expression extracted from the source code by the extraction unit 131, that is, a regular expression vulnerable to ReDoS. As a result, the synthesis unit 134 is prevented from performing the correction processing on the regular expression that is originally unnecessary to be corrected.

Further, since it is sufficient that the source code is input to the correction device 10 instead of the regular expression itself, for example, processing in a previous stage such as extracting the regular expression from the source code in advance can be omitted.

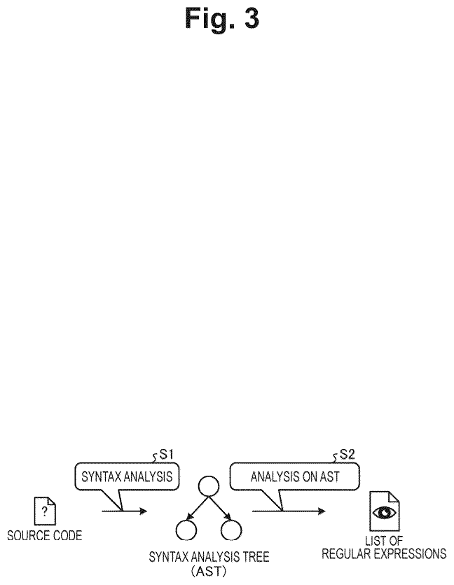

FIG. 3 is a diagram describing a method for extracting a list of regular expressions. As illustrated in FIG. 3, first, the extraction unit 131 performs syntax analysis on the source code to construct a syntax analysis tree (for example, abstract syntax tree (AST)) (step S1).

The extraction unit 131 can analyze the source code using a syntax analysis function provided according to a programming language describing the source code. For example, when the programming language is Python, the extraction unit 131 analyzes the source code using ANother Tool for Language Recognition (ANTLR) (reference: https://www.antlr.org/).

Further, the extraction unit 131 performs analysis on the AST to obtain a list of regular expressions (step S2). In this manner, the extraction unit 131 can create a list including the extracted one or more regular expressions.

The extraction unit 131 converts the source code into a syntax analysis tree, and extracts a regular expression restored on the basis of variables extracted from the syntax analysis tree as a regular expression before correction.

First, the extraction unit 131 traverses the AST, and extracts a regular expression in the source code, a variable name of each variable, and a set of values.

When a program based on the source code is executed, a regular expression may be generated by a combination of variables. Therefore, the extraction unit 131 restores the regular expression on the basis of the variable name and the set of values.

Processing in which the extraction unit 131 restores a regular expression will be specifically described by taking the below-described source code described by Python, which is a program language, as an example. Note that, for the sake of description, numbers for distinguishing lines are attached to the left end of each line of the source code.

### (Source Code)

| | |
|---|---|
| 1: | Import re |
| 2: | if input( ) == “example”: |
| 3: | s = “example.com” |
| 4: | else: |
| 5: | s = “example.com/abc” |
| 6: | r = ‘http://’ + s + “.*/index[.]html” |
| 7: | re.match(r, input( )) |

In this case, the value of the regular expression r is determined by a combination with the value of the variable s. Therefore, the regular expression r is not determined until the value of input( ) in the if sentence starting from the second line is determined.

The extraction unit 131 extracts a set of values {“example.com”, “example.com/abc” }corresponding to the variable (name) s, and restores the regular expression r using the set.

In this case, the extraction unit 131 restores “http://example.com.*/index[.]html” and “http://example.com/abc.*index[.]html” and extracts the regular expression as the regular expression r.

In a case where the regular expression satisfies RWS1U (reference: “Repairing DoS Vulnerability of Real-World Regexes”, https://www.computer.org/csdl/proceedings-article/sp/2022/131600b049/1A4Q3TnrBZK), the determination unit 132 determines that the regular expression is not vulnerable to ReDoS. On the other hand, when the regular expression does not satisfy RWS1U, the determination unit 132 determines that the regular expression is vulnerable to ReDoS.

The generation unit 133 performs the processing described below on the regular expression determined to be vulnerable to ReDoS by the determination unit 132 among the regular expressions included in the list of regular expressions.

The generation unit 133 generates positive examples, which are a set of character strings accepted by the regular expression before correction, and negative examples, which are a set of character strings rejected by the regular expression before correction.

Note that positive examples are an example of the first set. In addition, negative examples are an example of the second set.

The generation unit 133 converts the regular expression before correction into a nondeterministic finite automaton (NFA), generates a set of character strings obtained by a path reaching the acceptance state among paths on the nondeterministic finite automaton as positive examples, and generates a set of character strings obtained by a path not reaching the acceptance state among the paths on the nondeterministic finite automaton as negative examples.

The generation unit 133 constructs an NFA using the Thompson's construction method. However, since the capture and the backreference included in the regular expression cannot be handled by the Thompson's construction method, the generation unit 133 replaces the backreference with a regular expression in the capture referred to by the backreference by over-approximation.

For example, regarding the regular expression “(a*b) (c¥1)¥2”, the generation unit 133 replaces “¥1”, which is backreference in the capture (“(c¥1)”), with “a*b” to obtain “(a*b) (ca*b)¥2”. Further, the generation unit 133 replaces backreference “¥2” with “ca*b” to obtain “(a*b) (ca*b)ca*b”. Note that the capture is handled as a grouping in the Thompson's construction method, and thus is left as it is.

In this manner, the generation unit 133 replaces the backreference with the regular expression in the capture referred to by the backreference. When the capture includes another backreference, first, the backreference is replaced with the regular expression of the capture referred to by the backreference. As a result, since the backreference disappears from the regular expression, the Thompson's construction method can be used.

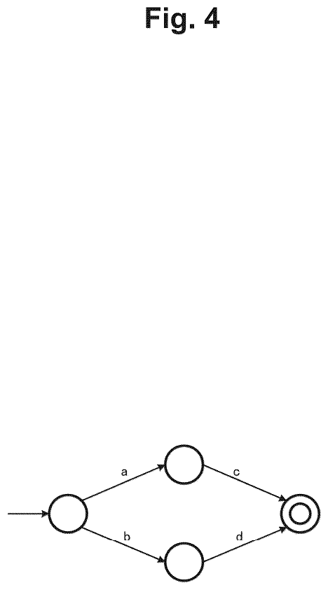

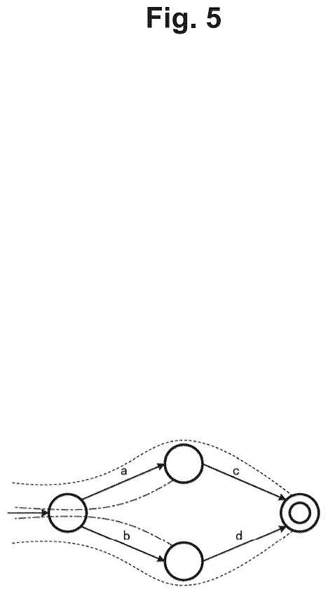

The generation unit 133 converts the regular expression from which the backreference in the capture has been removed into an NFA by the Thompson's construction method. FIG. 4 is a diagram illustrating an example of an NFA. FIG. 5 is a diagram illustrating an example of a path on an NFA. In FIGS. 4 and 5, the double circles indicate nodes in the acceptance state.

The generation unit 133 generates an example of following the path of the NFA. Since the path a-c and the path b-d (broken lines in FIG. 5) reach the acceptance state, the generation unit 133 generates a set of positive examples {ac,bd}. On the other hand, since the path a and the path b (dashed-dotted lines in FIG. 5) do not reach the acceptance state, the generation unit 133 generates a set of negative examples {a,b}.

Note that the generation unit 133 can enumerate paths using a known search algorithm such as breadth-first search or depth-first search. However, in a case where there is a loop on the NFA, the generation unit 133 records the path through which passage has occurred so as not to pass through the same path twice or more.

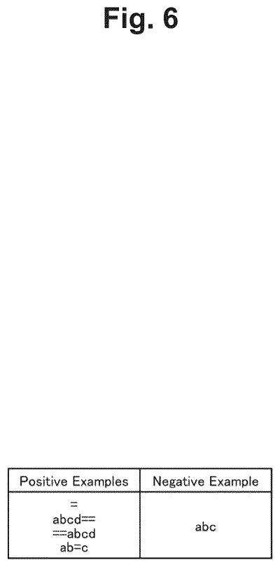

FIG. 6 is a diagram illustrating examples of positive examples and negative examples. Here, it is assumed that the regular expression before correction is “.*.*=.*”. At this time, “=”, “abcd==”, “==abcd”, and “ab=c” included in the positive examples match (accepted by) the regular expression “.*.*=.*”. On the other hand, “abc” included in the negative examples does not match (rejected by) the regular expression “.*.*=.*”.

The generation unit 133 can enumerate all character strings in which characters having a specific length or less are combined, classify each character string into the positive examples when the character string is accepted by the regular expression, and classify each character string into the negative examples when the character string is rejected. Note that the generation unit 133 may generate the positive examples and negative examples using the method described in Non Patent Literature 1.

Here, when all the character strings are simply enumerated, a tremendous number of examples are generated. In order to avoid this, the generation unit 133 may generate the character string of the positive examples and the character string of the negative examples only from the characters appearing in the regular expression before correction.

For example, in a case where the regular expression is “ab[c−d]*”, the generation unit 133 generates a candidate character string by combining “a” and “b” with one character randomly selected from “[c,d]”.

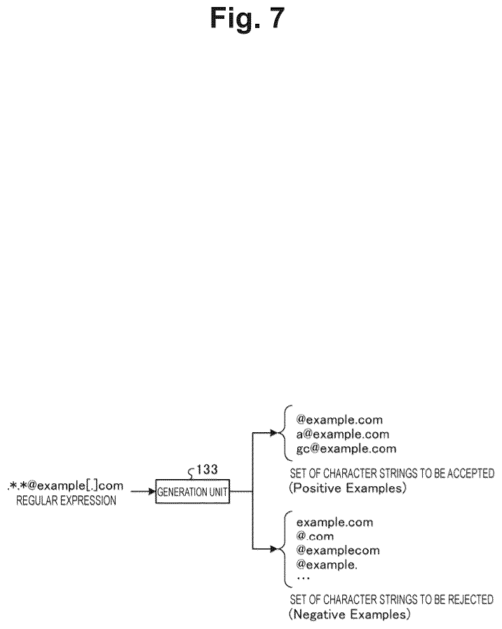

FIG. 7 is a diagram describing a method for generating a set of character strings. In the example of FIG. 7, the regular expression before correction is “.*.*@example[.]com”. In this case, the generation unit 133 classifies character strings “@example.com”, “a@example.com”, and “gc@example.com” accepted by the regular expression “.*.*@example[.]com” into the positive examples. On the other hand, the generation unit 133 classifies character strings “example.com”, “@.com”, “@examplecom”, “@example.”, and the like rejected by the regular expression “.*.*@example[.]com” into the negative examples.

The synthesis unit 134 synthesizes the corrected regular expression that is a regular expression obtained by replacing the range characters in the regular expression before correction with a predetermined syntax, that is, a regular expression that accepts a character string of the positive examples and rejects a character string of the negative examples.

The processing by the synthesis unit 134 is roughly divided into a step of creating a template and a step of performing assignment to the template.

In the step of creating a template, the synthesis unit 134 creates a template by replacing range characters in a regular expression with placeholders.

In the step of performing assignment to the template, the synthesis unit 134 assigns a predetermined syntax to the placeholder and synthesizes an invulnerable regular expression. Hereinafter, the placeholder is referred to as a hole and denoted as “□”.

The synthesis unit 134 performs processing while holding a priority queue. The template stored in a queue is given priority according to the closeness to the regular expression before correction. For example, a template closer to the regular expression before correction is given a higher priority. In addition, the closeness to the regular expression may be represented by a sum of sizes of different subtrees between ASTs of the regular expression (see, for example, Non Patent Literature 1).

When extracting an element from the queue, the synthesis unit 134 preferentially extracts a template with the highest priority among the stored templates. At the start of the processing, the synthesis unit 134 stores the regular expression before correction in the queue as a template. Note that the priority of the regular expression before correction stored in the queue is inevitably the highest.

First, a step of creating a template executed by the synthesis unit 134 will be described. When the template extracted from the queue includes a range character, the synthesis unit 134 replaces the range characters included in the template with holes. Note that the range characters are represented as, for example, “[C]” or “.”. On the other hand, in a case where the template extracted from the queue includes holes, the synthesis unit 134 may replace any one of the holes with a predetermined syntax.

For example, the synthesis unit 134 creates templates “□*.*=.*”, “.*□*=.*”, and “.*.*=□*” obtained by replacing the range characters of the regular expression before correction “.*.*=.*” stored in the queue as the template, and stores the templates in the queue. Note that it is assumed that the template extracted once is discarded.

In this manner, the synthesis unit 134 replaces at least some of the range characters in the regular expression before correction with holes, and synthesizes the corrected regular expression based on the template in which the replacement holes are further replaced with a predetermined syntax.

Further, the synthesis unit 134 can replace the holes with the syntax “□□”, “□|□”, “□*”, “(□)”, “¥i”, “(?=□)”, “(?!□)”, “(?<=□)”, or “(?<!□)” included in the replacement candidate syntax information 121. In this case, the synthesis unit 134 synthesizes the corrected regular expression based on the template (where, □ is a hole) in which the holes included in the template are replaced with any one of predetermined syntaxes including holes, that is, “□□”, “□|□”, “□*”, “(□)”, “¥i”, “(?=□)”, “(?!□)”, “(?<=□)”, and “(?<!□)”.

Next, a step of performing assignment to the template executed by the synthesis unit 134 will be described. Here, it is assumed that a step of creating a template by the synthesis unit 134 is repeated, and for example, a template “□*□*=.*” is created and stored in the queue. For example, the synthesis unit 134 obtains the template “□*□*=.*” by replacing the range character “.” on the left side of the template “□*.*=.*” with a hole.

The synthesis unit 134 searches for assignment of range characters satisfying conditions to the holes included in the template. For example, the synthesis unit 134 performs a search using Satisfiability Modulo Theories (SMT) solver (for example, Z3 solver) or the like.

When the template is “□*□*=.*” and the positive examples and the negative examples are as illustrated in FIG. 6, the synthesis unit 134 can obtain the assignment “[ ]*[\hat{ }=]*=.*” by the search. The synthesis unit 134 removes “[ ]” that is an empty set, and obtains a regular expression “[\hat{ }=]*=.*”.

The regular expression “[\hat{ }=]*=.*” accepts the positive examples in FIG. 6 and rejects the negative examples. In addition, since the regular expression “[\hat{ }=]*=.*” includes at most one place matching the same character, it can be said that the regular expression has an invulnerable property.

In the present embodiment, as described above, the regular expression that operates in a linear time on the regular expression engine with respect to the length of the character string to be matched is called an invulnerable regular expression. On the contrary, a regular expression that operates, for example, in exponential function time on the regular expression engine with respect to the length of the character string to be matched is called a vulnerable regular expression.

The synthesis of the invulnerable regular expression by the synthesis unit 134 uses a property obtained by improving the property of strongly one-unambiguous (reference: Christoph Koch and Stefanie Scherzinger. 2007. Attribute Grammars for Scalable Query Processing on XML Streams. The VLDB Journal 16, 3 (July 2007), 317-342.) devised by Koch and Scherzinger et al. also in accordance with extension in the real world.

Strongly one-unambiguous is a property that an operation to be processed next by the regular expression engine is uniquely determined when a character currently being analyzed is determined.

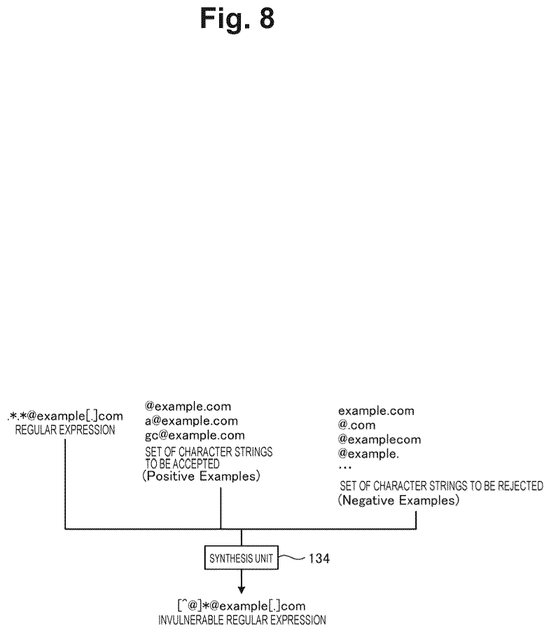

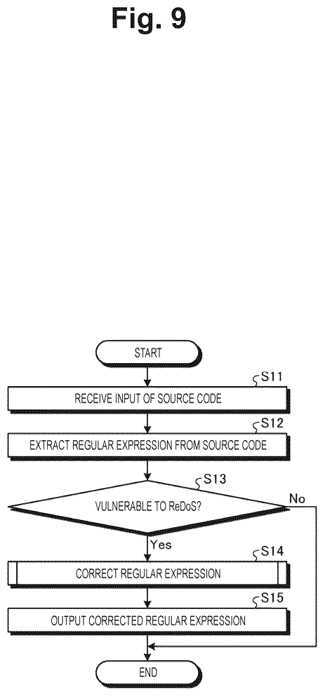

Similarly, in a case where the regular expression before correction is “.*.*@example[.]com”, as illustrated in FIG. 8, the synthesis unit 134 can obtain the invulnerable regular expression “[\hat{ }@]*@example[.]com”.

[Processing of First Embodiment] FIG. 9 is a flowchart illustrating a flow of processing of the correction device according to the first embodiment. As illustrated in FIG. 9, the correction device 10 first receives an input of a source code (step S11).

Next, the correction device 10 extracts a regular expression from the source code (step S12). For example, the correction device 10 extracts a regular expression using a syntax analysis function corresponding to a programming language describing the source code.

Subsequently, the correction device 10 determines whether the extracted regular expression is vulnerable to ReDoS (step S13).

In a case where the extracted regular expression is not vulnerable to ReDoS (step S13, No), the correction device 10 ends the processing.

Then, the correction device 10 corrects the regular expression determined to be vulnerable to ReDoS (step S13, Yes) (step S14). The correction device 10 outputs the corrected regular expression (step S15).

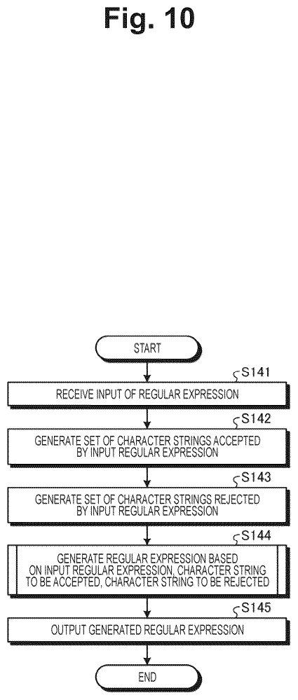

FIG. 10 is a flowchart illustrating a flow of processing of the correction device according to the first embodiment. The processing of FIG. 10 corresponds to step S14 of FIG. 9. First, the correction device 10 receives an input of a regular expression (step S141).

Next, the correction device 10 generates a set of character strings (positive examples) accepted by the input regular expression (step S142). In addition, the correction device 10 generates a set of character strings (negative examples) rejected by the input regular expression (step S143).

For example, the correction device 10 can create an extended automaton from the input regular expression before correction, and generate a set of character strings so as to cover all paths of the extended automaton.

Subsequently, the correction device 10 generates (synthesizes) a regular expression based on the input regular expression, the character string to be accepted, and the character string to be rejected (step S144). Then, the correction device 10 outputs the generated regular expression (step S145).

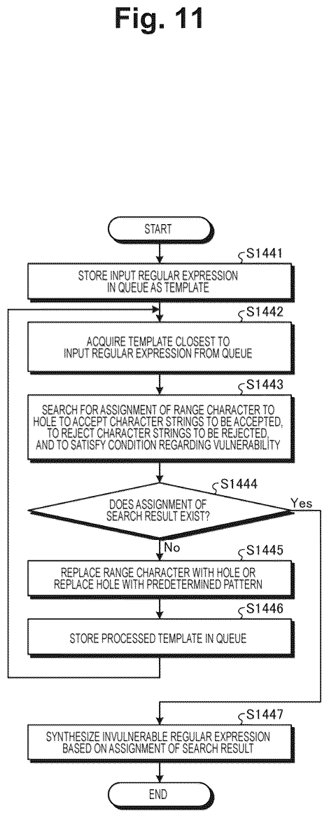

FIG. 11 is a flowchart illustrating a flow of regular expression synthesis processing. The processing of FIG. 11 corresponds to step S144 of FIG. 10. First, the correction device 10 stores the input regular expression in a queue as a template (step S1441).

Next, the correction device 10 acquires a template closest to the input regular expression from the queue (step S1442).

Subsequently, the correction device 10 searches for an assignment of a range character to the hole to accept the character strings to be accepted, to reject the character strings to be rejected, and to satisfy the condition regarding the vulnerability (step S1443).

The correction device 10 determines whether the assignment of the search result exists (step S1444). In a case where the assignment of the search result does not exist (step S1444, No), the correction device 10 replaces the range character with the hole or the hole with a predetermined pattern (step S1445). The predetermined pattern is, for example, a syntax such as “□□”, “□|□”, “□*”, “(□)”, “¥i”, “(?=□)”, “(?!□)”, “(?<=□)”, or “(?<!□)”. Note that, in a case where the input regular expression stored in the queue in step S1441 is the target of the search in step S1443, it is considered that there is no assignment (No) in step S1444.

Then, the correction device 10 stores the template processed in step S1445 in the queue (step S1446). The processed template here is a template in which the range character is replaced with the hole or a template in which the hole is replaced with a predetermined pattern.

On the other hand, in a case where the assignment of the search result exists (step S1444, Yes), the correction device 10 synthesizes an invulnerable regular expression based on the assignment of the search result (step S1447).

[Effects of First Embodiment] As described above, the extraction unit 131 of the correction device 10 extracts the first regular expression from the source code. The determination unit 132 determines whether the first regular expression satisfies a condition indicating that the first regular expression is vulnerable to ReDoS. The synthesis unit 134 synthesizes the second regular expression that does not satisfy the condition on the basis of the first regular expression. As a result, it is possible to efficiently correct vulnerability of a regular expression used in the real world. For example, the processing of extracting the regular expression from the source code in advance can be omitted.

Further, in the embodiment, a practical usage method such as testing a source code of a web application that is a target of a ReDoS attack is enabled. Further, the embodiment can be used for testing and diagnosing the security of the web application.

In addition, the extraction unit 131 converts the source code into a syntax analysis tree, and extracts a regular expression restored on the basis of variables extracted from the syntax analysis tree as a first regular expression. In this way, the regular expression used when the program is actually executed can be dynamically restored, and the regular expression to be corrected can be covered.

In addition, the generation unit 133 generates a first set that is a set of character strings accepted by the first regular expression and a second set that is a set of character strings rejected by the first regular expression. The synthesis unit 134 synthesizes a second regular expression that is a regular expression obtained by replacing range characters in the first regular expression with a predetermined syntax, that is, a regular expression that accepts character strings of the first set and rejects character strings of the second set. When such processing is performed, the processing can be made efficient by narrowing down regular expressions vulnerable to ReDoS.

The generation unit 133 converts the first regular expression into a nondeterministic finite automaton, generates a set of character strings obtained by a path reaching the acceptance state among paths on the nondeterministic finite automaton as a first set, and generates a set of character strings obtained by a path not reaching the acceptance state among the paths on the nondeterministic finite automaton as a second set. As a result, the regular expression to be corrected can be comprehensively acquired.

[System Configuration and the Like] In addition, each of components of the illustrated devices is functionally conceptual, and does not necessarily need to be physically configured as illustrated. That is, a specific form of distribution and integration of the devices is not limited to the illustrated form, and can be configured by functionally or physically distributing or integrating all or some thereof in any unit depending on various loads, use status, and the like. Further, the whole or any part of processing functions performed in the devices can be implemented by a central processing unit (CPU) and a program analyzed and executed by the CPU, or can be implemented as hardware by wired logic. Note that the program may be executed not only by a CPU but also by another processor such as a GPU.

In addition, among the pieces of processing described in the present embodiment, all or some of the pieces of processing described as being automatically performed can be manually performed, or all or some of the pieces of processing described as being manually performed can be automatically performed by a known method. Processing procedures, control procedures, specific names, and information including various types of data and parameters described in the above literature and drawings can be arbitrarily changed unless otherwise described.

[Program] As an embodiment, the correction device 10 can be implemented by installing a correction program for executing the above correction processing as packaged software or online software in a desired computer. For example, an information processing device can be caused to function as the correction device 10 by causing the information processing device to execute the above correction program. The information processing device described here includes a desktop or laptop personal computer. In addition, the information processing device also includes a mobile communication terminal such as a smartphone, a mobile phone, and a personal handyphone system (PHS), a slate terminal such as a personal digital assistant (PDA), and the like.

In addition, the correction device 10 can also be implemented as a correction server device that uses a terminal device used by the user as a client and provides the client with a service related to the correction processing described above. For example, the correction server device is implemented as a server device that provides a correction service in which the source code is used as an input and the corrected regular expression is used as an output. In this case, the correction server device may be implemented as a web server, or may be implemented as a cloud that provides a service related to the correction processing described above by outsourcing.

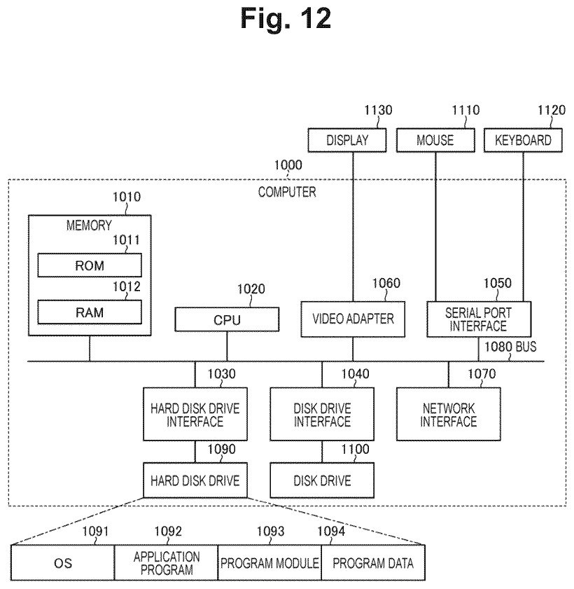

FIG. 12 is a diagram illustrating an example of a computer that executes a correction program. The computer 1000 includes a memory 1010 and a CPU 1020, for example. In addition, the computer 1000 includes a hard disk drive interface 1030, a disk drive interface 1040, a serial port interface 1050, a video adapter 1060, and a network interface 1070. These units are connected to each other via a bus 1080.

The memory 1010 includes read only memory (ROM) 1011 and random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. That is, the program that defines each processing of the correction device 10 is implemented as the program module 1093 in which codes executable by a computer are described. The program module 1093 is stored in, for example, the hard disk drive 1090. For example, the program module 1093 for executing processing similar to the functional configurations in the correction device 10 is stored in the hard disk drive 1090. Note that the hard disk drive 1090 may be replaced with a solid state drive (SSD).

In addition, setting data used in the processing in the embodiment described above is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and executes the processing of the embodiment described above.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

### REFERENCE SIGNS LIST

10 Correction device
11 Interface unit
12 Storage unit
13 Control unit
121 Replacement candidate syntax information
131 Extraction unit
132 Determination unit
133 Generation unit
134 Synthesis unit

1. A correction device comprising:
processing circuitry configured to:
extract a first regular expression from a source code;
determine whether the first regular expression satisfies a condition indicating that the first regular expression is vulnerable to Regular Expression Denial of Service (ReDoS); and
synthesize a second regular expression that does not satisfy the condition on a basis of the first regular expression.

2. The correction device according to claim 1, wherein the processing circuitry is further configured to convert the source code into a syntax analysis tree, and extract a regular expression restored on a basis of a variable extracted from the syntax analysis tree as the first regular expression.

3. The correction device according to claim 1, wherein the processing circuitry is further configured to:
generate a first set that is a set of character strings accepted by the first regular expression and a second set that is a set of character strings rejected by the first regular expression, and
synthesize a second regular expression that is a regular expression obtained by replacing range characters in the first regular expression with a predetermined syntax, that is, a regular expression that accepts a character string of the first set and rejects the character string of the second set.

4. The correction device according to claim 3, wherein the processing circuitry is further configured to convert the first regular expression into a nondeterministic finite automaton, generate a set of character strings obtained by a path reaching an acceptance state among paths on the nondeterministic finite automaton as the first set, and generate a set of character strings obtained by a path not reaching the acceptance state among the paths on the nondeterministic finite automaton as the second set.

5. A correction method executed by a correction device, the correction method comprising:
extracting a first regular expression from a source code;
determining whether the first regular expression satisfies a condition indicating that the first regular expression is vulnerable to Regular Expression Denial of Service (ReDoS); and
synthesizing a second regular expression that does not satisfy the condition on a basis of the first regular expression.

6. A non-transitory computer-readable recording medium storing therein a correction program for causing a computer to execute a process comprising:
extracting a first regular expression from a source code;
determining whether the first regular expression satisfies a condition indicating that the first regular expression is vulnerable to Regular Expression Denial of Service (ReDoS); and
synthesizing a second regular expression that does not satisfy the condition on a basis of the first regular expression.
